(19) United States
(12) Patent Application Publication
(10) Pub. No.: US 2026/0116586 A1
(43) Pub. Date: Apr. 30, 2026

(54) APPARATUS FOR RELEASABLY FASTENING PAYLOAD TO A SPACECRAFT

(71) Applicant: EXOLAUNCH GmbH, Berlin (DE)

(72) Inventors: Peter Schwarz, Salzburg (AT); Johannes Gruber, Salzburg (AT); Dmitriy Sternharz, Berlin (DE); Sergey Polyak, Berlin (DE)

(21) Appl. No.: 19/334,070

(22) Filed: Sep. 19, 2025

(30) Foreign Application Priority Data
Sep. 20, 2024 (EP) 24201692.1

(51) Int. Cl. B64G 1/64

(52) U.S. Cl. CPC B64G 1/641

(57) ABSTRACT

An apparatus for releasably fastening a payload to a spacecraft comprises a support for fastening to the spacecraft and a support ring for fastening to the payload, wherein a clamping ring for clamping the support ring to the support is provided.

### CROSS-REFERENCE TO RELATED APPLICATIONS

This application claims the benefit of foreign priority under 35 U.S.C. § 119 of European patent application number 24201692.1, filed Sep. 20, 2024. The contents of this application are incorporated herein by reference in their entirety.

### INTRODUCTION

The present invention relates to an apparatus for releasably fastening a payload to a spacecraft, said apparatus comprising a support for fastening to the spacecraft, a support ring for fastening to the payload, and a clamping ring, having a center axis, for clamping the support ring to the support.

Such apparatus are known from the prior art and serve to fixedly couple the payload to the spacecraft during the transport and to then release the payload in space. The fundamental problem here is that the payload should be fixedly coupled to the spacecraft, on the one hand. On the other hand, the release of the payload should not exert any undesirable forces on the payload in order to avoid undesirable wobbling movements and the like after the release of the payload. Finally, it is desirable for such apparatus to have a compact design since the space available in the region of the spacecraft is always limited.

It is therefore the object of the present invention to further develop an apparatus of the kind described above such that a fixed coupling of the support and the support ring can take place with a compact design without undesirable forces occurring on a release of the support ring and the support.

This object is satisfied by the features of claim 1 and in particular in that the clamping ring can be moved along its center axis from a clamping position, in which the support ring and the support are clamped to one another, in an in particular exclusively translatory movement into a release position in which the support ring can be released from the support.

With the solution according to the invention, the major advantage results that the clamping ring can be transferred from its clamping position into the release position in the clamped state without the preload of the clamping ring having to be released in the process. Since the forces exerted by the clamping ring are oriented perpendicular to its center axis, i.e. radially inwardly, these clamping forces can be maintained until the clamping ring is transferred along its center axis from the clamping position into the release position. Up to this point in time, the support and the support ring are, however, connected to one another without play due to the effect of the clamping ring. Moreover, due to the purely axial movement of the clamping ring, no forces with a component in the peripheral direction are exerted on the support ring (and thus also on the payload) during the release.

Advantageous embodiments of the invention are described in the description, in the drawing and in the dependent claims.

### SUMMARY

According to a first advantageous embodiment, the clamping ring can be in an operative connection with clamping levers that are mounted at the support, wherein the clamping levers wedge the support ring against the support. By exerting a radially inwardly directed clamping force, the clamping ring can apply a force to the clamping levers that are, for example, arranged spaced apart over the periphery of the support ring so that all the clamping levers exert a clamping force between the support ring and the support. If support surfaces of the clamping levers and/or of the support ring are wedge-shaped, a connection without play can hereby be achieved with high clamping forces.

According to a further advantageous embodiment, a toggle lever can be present between the clamping ring and each clamping lever. The translatory movement of the clamping ring can hereby be converted into a rotational movement of the clamping levers. In this respect, it can also be advantageous if the toggle lever has reached its dead center in the clamping position, but has not exceeded it. The clamping ring can in this respect be tensioned, for example by a tightening at a separation point, whereby the clamping force that is hereby generated is transmitted uniformly to all the clamping levers. Since the toggle levers are in their dead center position in this clamping position, they cannot buckle, but rather transmit the force exerted by the clamping ring to the clamping levers.

Furthermore, it can be advantageous if the clamping ring is coupled to a lifting ring that is movable, in particular exclusively movable in a translatory manner, along the center axis since a lifting movement of the lifting ring can be transmitted by such a lifting ring to the clamping ring in order to also move the latter in a translatory manner.

According to a further advantageous embodiment, it can be advantageous if the toggle lever is connected in an articulated manner at its one end to the clamping lever and is supported in a floating manner at its other end in the lifting ring in the radial direction. Due to such a floating support of the toggle lever in the radial direction, it is ensured that a radially inwardly directed clamping force of the clamping ring is uniformly transmitted to all the clamping levers.

According to a further advantageous embodiment, the clamping ring can be connected to the lifting ring via rollers, in particular via roller pairs. If a contact between the clamping ring and the lifting ring namely takes place solely via rollers, the friction between the clamping ring and the lifting ring is minimized, on the one hand. On the other hand, the clamping ring can move in the peripheral direction relative to the lifting ring during the clamping—again with little friction—if the clamping ring reduces its diameter (even if only slightly). If roller pairs are provided as a contact between the clamping ring and the lifting ring, an occurrence of tilting moments is additionally counteracted.

To effect a lifting movement of the lifting ring, it can furthermore be advantageous if the lifting ring can be moved by means of a control ring that is in particular rotatable exclusively about the center axis. Such a control ring can be preloaded in a manner known per se and can be rotated about a predetermined angle by actuating a release apparatus. To convert this rotational movement into a translatory lifting movement of the lifting ring, it can furthermore be advantageous if the control ring is connected to the lifting ring via pivot levers.

In order to move the control ring for transferring the lifting ring and the clamping ring into the release position, it can be advantageous if, in the clamping position, the control ring is preloaded against the force of one or more springs in the peripheral direction. It can also be advantageous if, in the clamping position, the lifting ring is preloaded against the force of one or more springs in the axial direction. If the preloaded control ring is then released by actuating a release apparatus, it moves rotationally due to its preload, whereby the lifting ring is translationally moved and indeed together with the clamping ring. This movement can be supported by the force of the at least one spring with which the lifting ring is preloaded in the clamping position.

According to an advantageous embodiment, the clamping ring can, at a separation point, have a clamping screw comprising two oppositely oriented threads. The clamping ring can hereby be easily tensioned by turning this screw when said clamping ring is in the clamping position. Such a clamping screw represents a very simple, effective and compact means to tighten a clamping ring.

According to a further advantageous embodiment, the apparatus can be configured such that the diameter of the clamping ring does not increase on a transition from the clamping position into the release position, i.e. the clamping ring is not, for instance, opened, blown open or otherwise separated on the release of the clamping. Rather, the clamping ring remains closed after the release and at most reduces its diameter slightly. Unwanted influences when releasing the payload can hereby also be avoided.

According to a further aspect, the present invention also relates to a method for fastening and releasing a support ring to and from a support of a spacecraft, wherein an apparatus of the kind described herein can be used for this purpose, but does not have to be used. In the method, the support ring, which is usually connected to a payload, is clamped to the support of the spacecraft with the aid of a clamping ring that is connected via toggle levers to clamping elements that clamp the support ring against the support. The clamping elements can be clamping levers that can be pivoted. However, other clamping elements are also possible, such as pawls, locking bolts, sliding wedges or similar. In the method, in order to fasten the support ring, the toggle levers are transferred from a bent position into a dead center position with the aid of the clamping ring so that the clamping ring, via the toggle levers, can transfer clamping forces to the clamping elements in the dead center position. The clamping ring can then be clamped at a separation point, whereby its diameter is slightly reduced and the clamping force of the clamping elements that exert said force is increased. If the payload is to be released in space, the support ring must be released from the support. For this purpose, in the method, the toggle levers are moved from their dead center position into a bent position, wherein the clamping elements are thereby released from the support ring. The bent position when releasing the support ring can but does not have to be identical to the bent position before the fastening of the support ring.

The toggle levers can comprise two or more pivot points. The toggle levers can thereby also be moved from their dead center position into a bent position by moving the clamping ring parallel to its center axis in a translatory movement. However, other mechanisms are also possible here. For example, the toggle levers can be released from their dead center position by means of a separate mechanism, i.e. not by means of the clamping ring.

### BRIEF DESCRIPTION OF THE DRAWINGS

The present invention will be described in the following purely by way of example with reference to an advantageous embodiment and to the enclosed drawings. There are shown:

FIG. 1 is a perspective view of an apparatus for releasably fastening a payload to a spacecraft, wherein a support ring is released from a support in FIG. 1;

FIG. 2 is a perspective sectional view along the line II-II of FIG. 1;

FIG. 3 is a view corresponding to FIG. 2, but in a clamping position;

FIG. 4 is a perspective partial view of FIG. 1 without a clamping ring and a lifting ring;

FIG. 5 is a partly sectioned perspective view of a section of FIG. 1 in a release position;

FIG. 6 is a view of FIG. 5 in a clamping position; and

FIG. 7 is a plan view of the sectional surface of FIG. 2 but in a clamping position.

### DETAILED DESCRIPTION

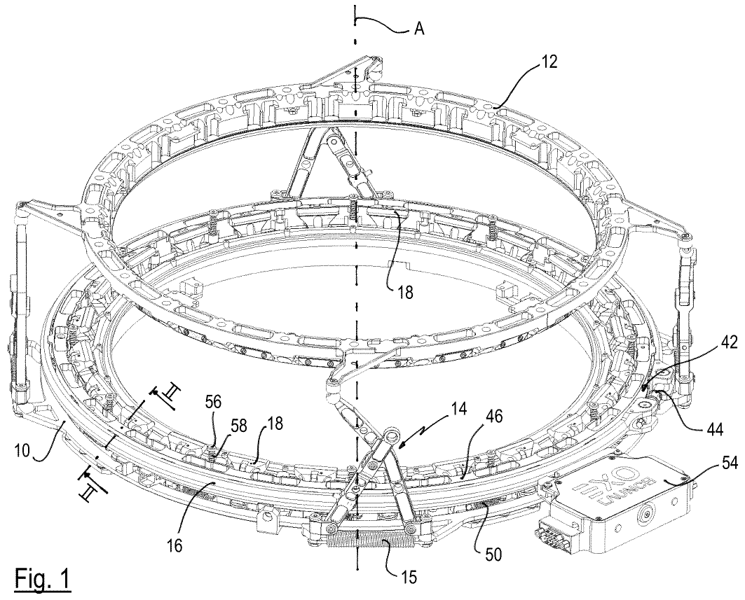

FIG. 1 shows a perspective view of an apparatus for releasably fastening a payload (not shown) to a spacecraft (likewise not shown). The apparatus has a support 10 for fastening to the spacecraft and a support ring 12 for fastening to the payload. Via a suitable ejection mechanism, the support ring 12 can be ejected with the payload fastened thereto after the support ring has been released from the support.

In the embodiment shown, the ejection device comprises a plurality of scissor levers 14 that are arranged distributed over the periphery of the support 10 and that can be brought into the position shown in FIG. 1 by springs 15. The support ring 12 is in this respect supported disposed on an outer free end of an arm of the scissor lever in each case so that the support ring 12 with the payload fastened thereto can lift off from these free ends in space.

It should be noted that the ejection mechanism shown is purely exemplary and that a wide variety of mechanisms can be used that ensure that the support ring is moved away from the support after the release, for example, a central coil spring.

For the transport into space, the support ring must be fixedly connected to the support 10 without play. For this purpose, the apparatus shown has a clamping ring 16 that has a center axis A and that serves to clamp the support ring 12 to the support 10.

In the embodiment example shown, the support 10 and the support ring 12 are formed in a circular ring shape with a common center axis A. However, it is understood that other ring shapes are also possible in principle and that the support 10 can also have other designs as long as it is ensured that the support ring 12 can be releasably fastened to the support 10 by means of the clamping ring 16.

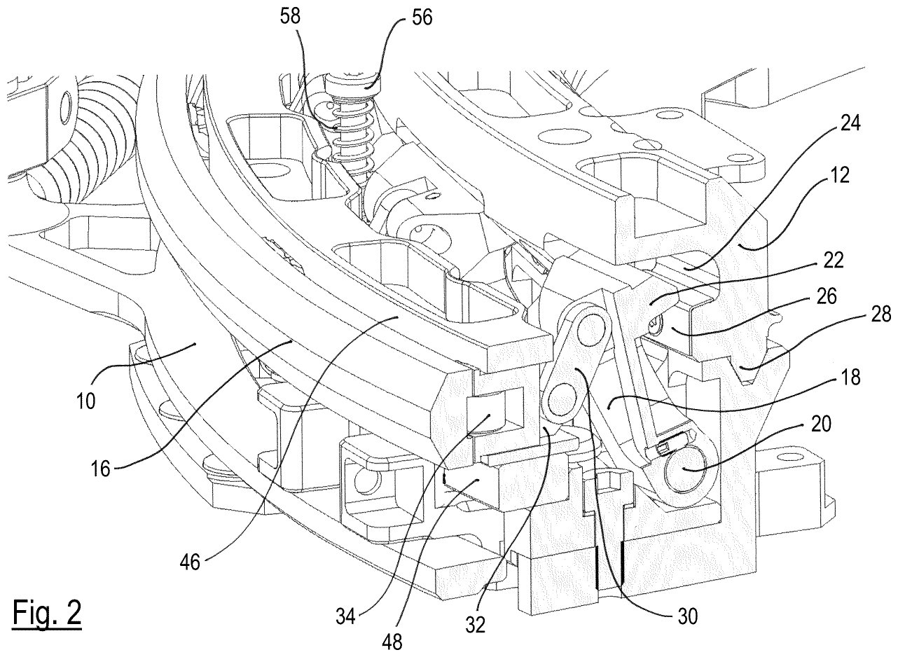

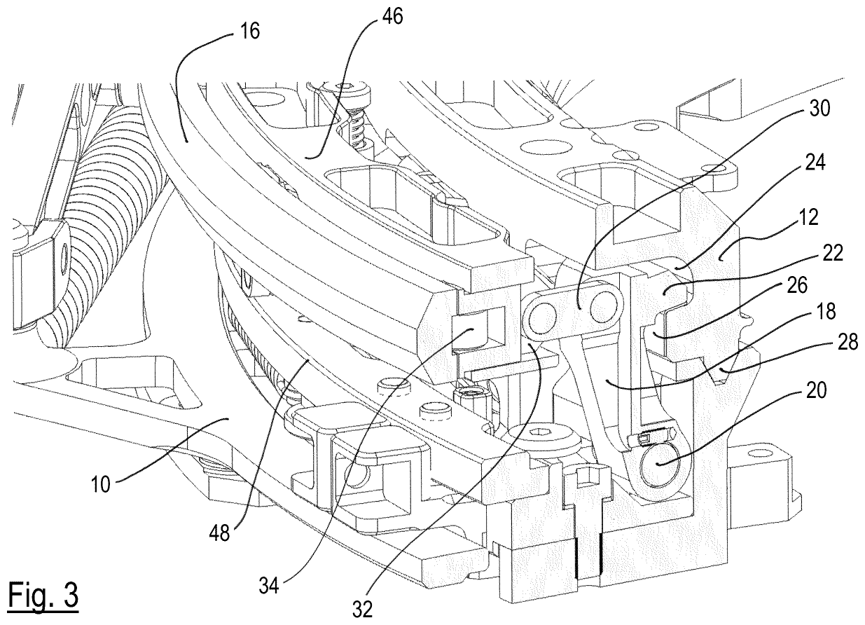

To fasten the support ring 12 to the support 10, clamping levers 18 are mounted at the support 10 and are each supported at their lower end on tangentially oriented shafts 20 (cf. FIGS. 2 and 3). The opposite upper end of each clamping lever 18, on the other hand, is provided with a locking projection 22 that extends in the radial direction and that can be pivoted into an associated locking recess 24 of the support ring 12. A friction-reducing sliding support 26 for the support surface of the clamping lever 18 can be applied or attached in the locking recess 24. The support surfaces between the locking projection 22 and the support ring 12 are also wedge-shaped (oriented at an angle to a plane orthogonal to the center axis A) so that, on a pivoting of the clamping levers 22 into the locking recess 24, a clamping force directed in a perpendicular manner downwardly in the direction of the support 10 is exerted on the support ring 12.

As FIGS. 2 and 3 furthermore illustrate, the support ring 12 has, at its underside, an annular flange 28 that has a V-shaped cross-section that fits into a mutually complementary annular groove of the support 10 in order to ensure a stable fit of the support ring 12 on the support 10. It is understood that other designs are also possible here to ensure a tight fit of the support ring 12 on the support 10, for example, individual pins, protrusions, recesses or the like.

FIG. 2 and FIG. 3 furthermore illustrate that the clamping ring 16 does not directly contact the support ring 12 or the support 10 in order to clamp them together. Rather, in the embodiment shown, the clamping ring 16 acts indirectly on the support ring 12, namely via the clamping levers 18 that are each coupled to the clamping ring 16 via a toggle mechanism 30, 32. Each toggle lever comprises a pivot lever 30 that, with its end, is connected in an articulated manner to the upper end of the clamping lever 18. The other end of the pivot lever 30 is connected in an articulated manner to a roller receiver 32 that is likewise part of the toggle lever mechanism.

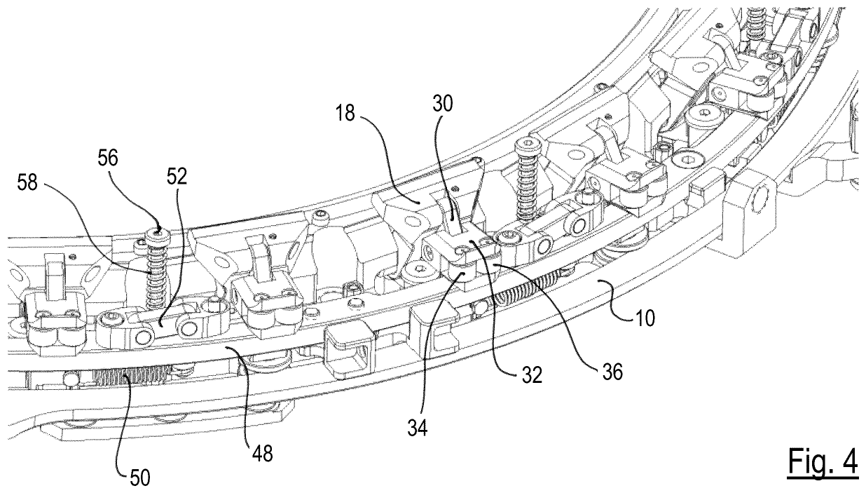

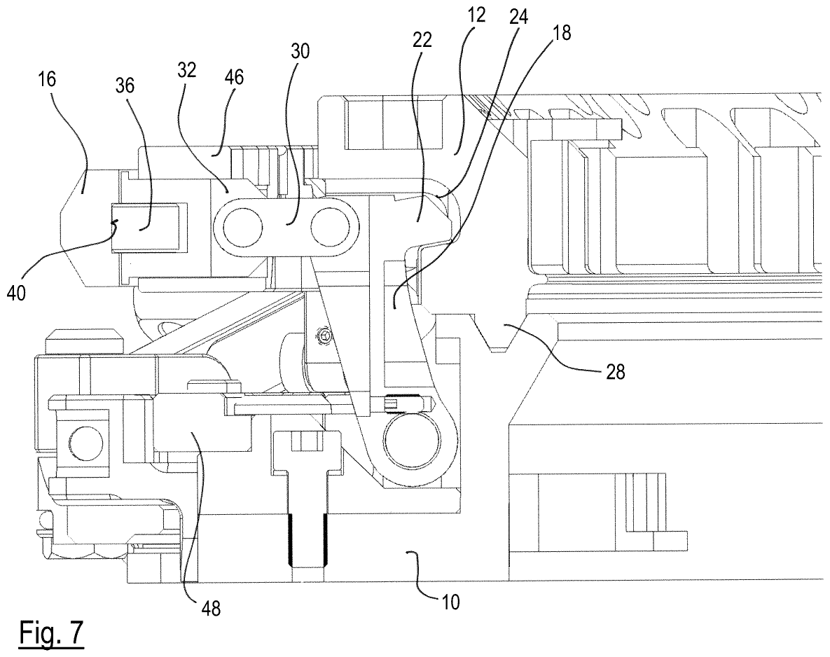

FIG. 4 perspectively shows the connection of the roller receiver 32 to the clamping lever 18 via the pivot lever 30, wherein it can be seen that the roller receiver 32 supports a respective two rollers 34 and 36 that are fastened to the roller receiver 32 via roller axles oriented parallel to the center axis. As FIGS. 2, 3 and 7 illustrate in this respect, all the rollers 34, 36 are guided only at their radially outermost peripheral section in a U-shaped annular groove 40 (FIG. 7) at the inner periphery of the clamping ring 16. The clamping ring 16 can hereby be tightened (tensioned) in the clamping position shown in FIG. 3, wherein, during the reduction in diameter of the clamping ring 16 that takes place in the process, the clamping ring 16 can slide along the rollers 34 and 36 in a low-friction manner.

To tension the clamping ring 16, it has one, for example a single, separation point 42 (FIG. 1). At this separation point 42, the clamping ring 16 is provided with a clamping screw 44 that, at its two ends, in each case has oppositely oriented threads that are screwed into the clamping eyes of the clamping ring 16. In FIG. 1, it can be seen that rotatably supported threaded inserts are mounted in the clamping eyes in order not to introduce bending forces into the clamping ring 16 and the clamping screw 44 on a tightening of the clamping screw 44. By turning the clamping screw 44, the diameter of the clamping ring 16 can be changed so that said clamping ring 16 can be tightened, which in turn effects an increase of the clamping force exerted on the clamping levers 18.

As a comparison of FIG. 2 and FIG. 3 illustrates, the clamping ring 16 can be moved from the clamping position (FIG. 3) into the release position (FIG. 2), and vice versa, in an exclusively translatory movement (parallel to the center axis A) in the embodiment example shown. When the clamping ring 16 is in its release position, the levers 30 and 32 are bent and the clamping lever 18 is pivoted so far that the locking projection 22 is pivoted out of the locking recess 24. Due to the translatory movement of the clamping ring 16 upwardly from the release position, the clamping position shown in FIG. 3 results. In said clamping position, the toggle lever mechanism 30, 32 has reached its dead center, but has not exceeded it so that the pivot axes of the levers 30 and 32 of the toggle lever are arranged on a straight line extending orthogonally to the center axis A and the locking projection 22 of the clamping lever 18 is wedged in the locking recess 24. In this position, all the clamping levers 16 can additionally be acted on by a force in the radial direction by turning the clamping screw 44 in order to increase the clamping force exerted on the support ring 12. From this state, however, the clamping ring 16 can nevertheless be moved into the release position by moving the clamping ring 16 parallel to the center axis A in the direction of the support 10 (downwards), whereby the toggle levers 30, 32 are released from their dead center position and bend open.

To move the clamping ring 16 in a direction parallel to the center axis A, said clamping ring 16 is coupled to a lifting ring 46 that is likewise exclusively movable in a translatory manner, wherein the outer diameter of the lifting ring 46 corresponds approximately to the inner diameter of the clamping ring 16. In the lifting ring 46, the roller receivers 32 are mounted in a floating manner in the radial direction so that the roller receivers 32 can move freely in the radial direction. A contact between the clamping ring 16 and the lifting ring 46 in this respect takes place exclusively within the annular groove 40 of the clamping ring 16 via the lateral surfaces of the rollers 34 and 36 located there.

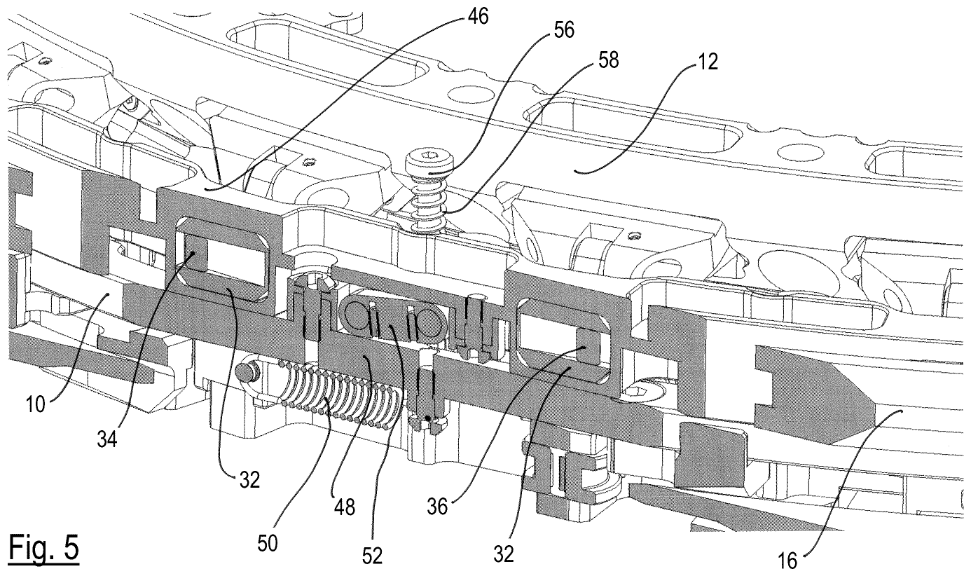

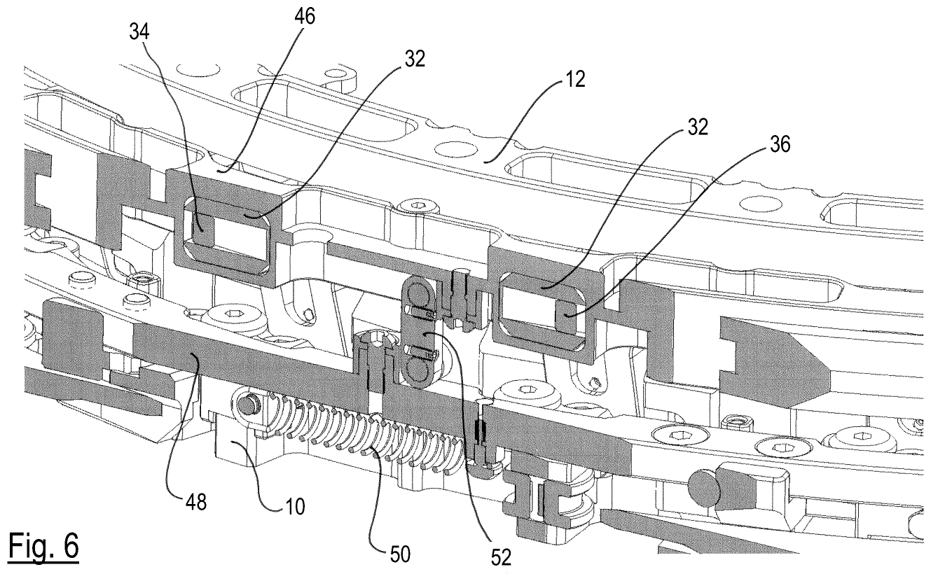

A control ring 48 arranged below the lifting ring 46 is provided for the translatory movement of the lifting ring 46. Said control ring 48 is rotatably supported in the support 10 about the center axis A and can be rotated by a predetermined angle of rotation with the aid of springs 50 in order to transfer the lifting ring 46 from the clamping position (FIG. 3 and FIG. 6) into the release position (FIG. 2 and FIG. 5). To convert the rotational movement of the control ring 48 into the lifting movement of the lifting ring 46, the two rings are connected to one another via pivot levers 52, wherein the pivot levers 52 are connected in an articulated manner to the control ring 48 at their one end and to the lifting ring 46 at their other end. In the release position, the pivot levers 52 are oriented at a small acute angle relative to the control ring 48 so that they are pivoted by a rotational movement of the control ring 48 when the latter is moved relative to the lifting ring 46.

In the clamping position shown in FIG. 6, the clamping levers 52 are oriented at right angles to the control ring 48 and the lifting ring 46 so that the lifting ring 46 and thus also the clamping ring 16 are fixedly held in this position. In this position, the springs 50 are tensioned and the control ring 48 is held in this tensioned position by a release apparatus 54 (FIG. 1) that locks the control ring 48 in this position. This blockage can be released by an electrical release signal so that the control ring 48 is rotated by the springs 50 in the peripheral direction about the center axis A, whereupon the pivot levers 52 move from the position shown in FIG. 6 into the release position shown in FIG. 5. In this respect, the lifting ring 46 that cannot rotate about the center axis A is lowered and the toggle lever 30, 32 is released from its dead center position (FIG. 3) so that all the clamping levers 18 release the support ring 12.

In order to apply additional forces to the lifting ring 46 during the movement of the latter from the clamping position into the release position, the lifting ring 46 is guided along its periphery at guide pins 56 that are surrounded by coil springs 58. In this respect, the coil springs 58 are tensioned on the transition from the release position into the clamping position so that the lifting ring 46 is preloaded in the clamping position by the force of these springs 58. After releasing the control ring 48, these springs exert an additional force on the lifting ring 46 parallel to the center axis A to transfer said lifting ring 46 from its clamping position into the release position.

As can be seen from the above description, the clamping ring 16 surrounds the support ring 12 in the region of its outer periphery, i.e. at its outer side, wherein the diameter of the clamping ring 16 does not change on a change between the clamping position and the release position. The clamping ring 16 therefore does not need to be opened or widened for a release of the support ring 12. Furthermore, a clamping force exerted by the clamping ring 16 (on the clamping levers 18) is oriented orthogonally to the direction of movement of the clamping ring 16 when the latter is transferred into the clamping position. Thus, the clamping ring 16 is moved parallel to the center axis A, i.e. axially, on the transition into the clamping position, whereas the clamping force exerted by the clamping ring is oriented radially in the direction of the center axis A.

1-15. (canceled)

16. An apparatus for releasably fastening a payload to a spacecraft, said
apparatus comprising
a support for fastening to the spacecraft,
a support ring for fastening to the payload, and
a clamping ring, having a center axis, for clamping the support ring to the support,
wherein the clamping ring can be moved along its center axis from a clamping position, in which the support ring and the support are clamped to one another, into a release position in which the support ring can be released from the support.

17. The apparatus according to claim 16,
wherein the clamping ring can be moved along its center axis from the clamping position, in which the support ring and the support are clamped to one another in an exclusively translatory movement into the release position in which the support ring can be released from the support.

18. The apparatus according to claim 16,
wherein the clamping ring is in an operative connection with clamping levers that are mounted at the support and that wedge the support ring against the support.

19. The apparatus according to claim 18,
wherein a toggle lever is present between the clamping ring and each clamping lever.

20. The apparatus according to claim 19,
wherein the toggle lever has reached its dead center in the clamping position and has not exceeded it.

21. The apparatus according to claim 16,
wherein the clamping ring is coupled to a lifting ring that is movable along the center axis.

22. The apparatus according to claim 21,
wherein the lifting ring is exclusively movable in a translatory manner along the center axis.

23. The apparatus according to claim 21,
wherein the clamping ring is in an operative connection with clamping levers that are mounted at the support and that wedge the support ring against the support and wherein the toggle lever is connected in an articulated manner at its one end to the clamping lever and is supported in a floating manner at its other end in the lifting ring in the radial direction.

24. The apparatus according to claim 21,
wherein the clamping ring is connected to the lifting ring via rollers.

25. The apparatus according to claim 24,
wherein the clamping ring is connected to the lifting ring via roller pairs.

26. The apparatus according to claim 21,
wherein the lifting ring can be moved by means of a control ring that is rotatable about the center axis.

27. The apparatus according to claim 26,
wherein the control ring is rotatable exclusively about the center axis.

28. The apparatus according to claim 26,
wherein the control ring is connected to the lifting ring via a pivot lever.

29. The apparatus according to claim 27,
wherein, in the clamping position, the control ring is preloaded against the force of at least one spring in the peripheral direction.

30. The apparatus according to claim 21,
wherein, in the clamping position, the lifting ring is preloaded against the force of at least one spring in the axial direction.

31. The apparatus according to claim 16,
wherein the clamping ring has, at a separation point, a clamping screw comprising two oppositely oriented threads.

32. The apparatus according to claim 16,
wherein the diameter of the clamping ring does not increase on a transition from the clamping position into the release position.

33. The apparatus according to claim 16,
wherein a clamping force exerted by the clamping ring is oriented orthogonally to the direction of movement of said clamping ring.

34. A method for fastening and releasing a support ring to and from a support of a spacecraft, wherein the support ring is clamped to the support with the aid of a clamping ring that is connected via toggle levers to clamping elements that clamp the support ring against the support, wherein
for fastening the support ring
the toggle levers are transferred from a bent position into a dead center position with the aid of the clamping ring, and then
the clamping ring is clamped at a separation point, and for releasing the support ring from the support
the toggle levers are transferred from the dead center position into a bent position and the clamping elements are thereby released from the support ring.
